(19) United States
(12) Patent Application Publication
(10) Pub. No.: US 2015/0153827 A1
(43) Pub. Date: Jun. 4, 2015

(54) CONTROLLING CONNECTION OF INPUT DEVICE TO ELECTRONIC DEVICES

(71) Applicant: QUALCOMM INCORPORATED, San Diego, CA (US)

(72) Inventors: Sungrack Yun, Seoul (KR); Taesu Kim, Seongnam (KR); Minho Jin, Anyang (KR)

(73) Assignee: QUALCOMM INCORPORATED, San Diego, CA (US)

(21) Appl. No.: 14/096,809

(22) Filed: Dec. 4, 2013

(51) Int. Cl. G06F 3/01; G06K 9/00

(52) U.S. Cl. CPC G06F 3/013; G06K 9/00288

(57) ABSTRACT

A method, performed by a connection manager, for connecting an input device and one of a plurality of electronic devices as a target device is disclosed. The method includes detecting a face of a user in a captured image, and determining a first gaze direction of the user from the face of the user in the captured image. Based on the first gaze direction, the method determines the target device in the plurality of electronic devices and connects the input device and the target device.

### TECHNICAL FIELD

The present disclosure relates to connecting an input device to a plurality of electronic devices, and more specifically, to connecting an input device to a target device from a plurality of electronic devices.

### BACKGROUND

With the proliferation of electronic devices such as mobile devices, desktop computers, laptop computers, tablet PCs, etc., users may have multiple electronic devices at their disposal. For example, a user may operate a desktop computer and a laptop computer on his or her desk to perform multiple tasks. In this case, the user may use the desktop computer to send an e-mail message and operate the laptop computer to watch a video clip through the Internet.

Generally, electronic devices include an input device such as a keyboard to allow the user to input commands and data. Such a configuration may not be convenient for a user. For example, the user may need to change his or her position physically to move from an input device in one electronic device to an input device in another electronic device.

In a conventional method, a single input device may be connected to a switching device, such as a KVM (Keyboard Video Mouse) switch, which is then connected to a plurality of electronic devices. The user then connects the input device manually to a desired electronic device by designating the connection to the desired electronic device in the switch. However, such a manual approach may not be convenient to the user since it may interrupt the user's task. Further, if the number of electronic devices increases or the frequency in switching from one device to another device increases, it may reduce the efficiency of the user in performing multiple tasks.

### SUMMARY

The present disclosure relates to controlling a connection of an input device to electronic devices by determining the user's gaze direction.

According to one aspect of the present disclosure, a method, performed by a connection manager, for connecting an input device and one of a plurality of electronic devices as a target device is disclosed. The method includes detecting a face of a user in a captured image, and determining a first gaze direction of the user from the face of the user in the captured image. Based on the first gaze direction, the target device is determined in the plurality of electronic devices, and the input device is connected to the target device. This disclosure also describes an apparatus, a device, a combination of means, and a computer-readable medium relating to this method.

According to another aspect of the present disclosure, an electronic device for connecting an input device and one of a plurality of electronic devices as a target device is disclosed. The electronic device includes a face detection unit, a gaze direction determining unit, and a communication control unit. The face detection unit is configured to detect a face of a user in a captured image. The gaze direction determining unit is configured to determine a first gaze direction of the user from the face of the user in the captured image, and determine the target device in the plurality of electronic devices based on the first gaze direction. Also, the communication control unit is configured to connect the input device and the target device.

### BRIEF DESCRIPTION OF THE DRAWINGS

Embodiments of the inventive aspects of this disclosure will be understood with reference to the following detailed description, when read in conjunction with the accompanying drawings.

FIG. 1 illustrates a plurality of electronic devices that may be connected to an input device based on a gaze direction of a user, according to one embodiment of the present disclosure.

FIG. 2 illustrates an input device configured to switch its connection from an electronic device to another electronic device in response to a change in a gaze direction of a user, according to one embodiment of the present disclosure.

FIG. 3 illustrates a block diagram of an electronic device configured to make a connection with an input device based on a gaze direction of a user, according to one embodiment of the present disclosure.

FIG. 4 illustrates a flow chart of a method for determining an electronic device as a target device for connecting to an input device, according to one embodiment of the present disclosure.

FIG. 5A illustrates a plurality of electronic devices that may be connected to an input device via a connection manager based on a gaze direction of a user, according to one embodiment of the present disclosure.

FIG. 5B illustrates a plurality of electronic devices that may be connected to an input device via a connection manager equipped with an image sensing unit, according to one embodiment of the present disclosure.

FIGS. 6A and 6B illustrate an electronic device connected with an input device and configured to display pop-up windows indicating status data received from a plurality of electronic devices, according to one embodiment of the present disclosure.

FIG. 7 illustrates a flow chart of a method in which a target device connected to an input device receives status data of other electronic devices which are not connected to the input device, according to one embodiment of the present disclosure.

FIG. 8 illustrates a plurality of electronic devices that may verify a user in a received image having the same face that was detected in previously captured images, according to one embodiment of the present disclosure.

FIG. 9 illustrates a flow chart of a method for determining a user for an input device when two users are detected, according to one embodiment of the present disclosure.

FIG. 10 is a block diagram of an exemplary electronic device in which the methods and apparatus for controlling a connection of an input device to electronic devices based on a user's gaze direction may be implemented, according to one embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the inventive aspects of this disclosure. However, it will be apparent to one of ordinary skill in the art that the inventive aspects of this disclosure may be practiced without these specific details. In other instances, well-known methods, procedures, systems, and components have not been described in detail so as not to unnecessarily obscure aspects of the various embodiments.

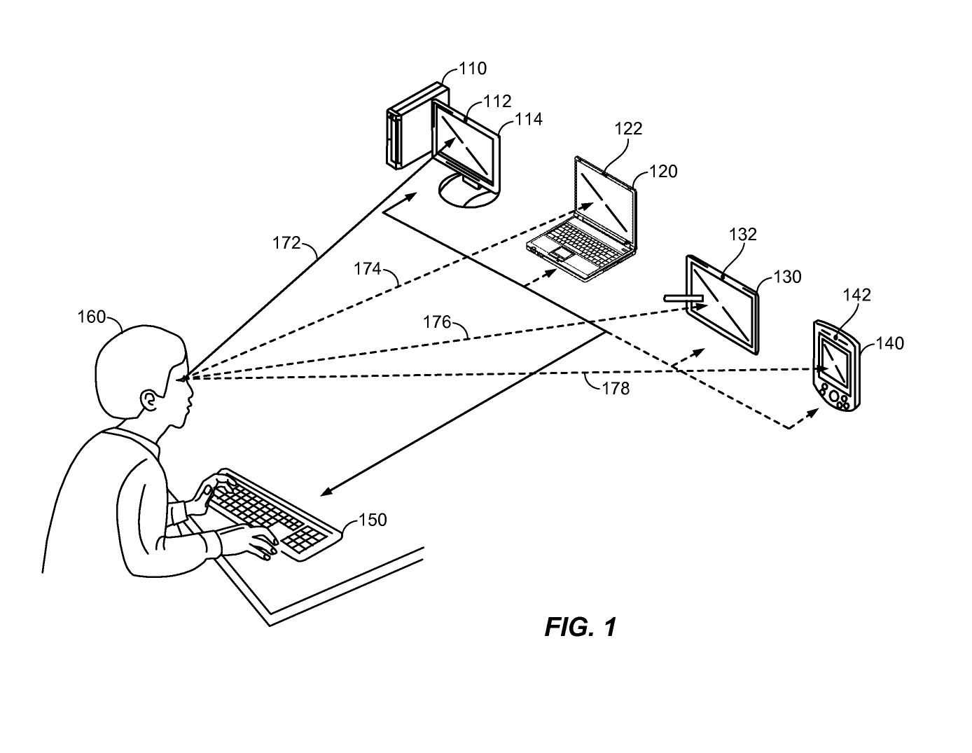

FIG. 1 illustrates a plurality of electronic devices 110, 120, 130, and 140 that may be connected to an input device 150 based on a gaze direction of a user 160 according to one embodiment of the present disclosure. As used herein, the term “gaze direction” refers to a direction along which a person is looking (e.g., a line of sight), and may include a direction to an object, such as the electronic device 110, 120, 130, or 140, at which the person may be looking. As shown, the electronic devices 110, 120, 130, and 140 are located near the user 160 who may operate any of the electronic devices 110 to 140 by using the input device 150 based on his or her gaze direction. The electronic devices 110, 120, 130, and 140 are illustrated with a desktop computer, a laptop computer, a tablet computer, and a mobile device (e.g., a mobile phone, a hand-held gaming device, etc.), respectively, and may be equipped with a wireless and/or wired communication capability for communicating with each other or the input device. The electronic devices 110 to 140 may be implemented by any suitable devices with such communication capability such as a smartphone, a smart television, a gaming system, a multimedia player, etc.

The input device 150 may be a keyboard that can be connected to any one of the electronic devices 110, 120, 130, and 140. In one embodiment, the keyboard may be a wireless keyboard that can communicate using a short range wireless communication technology such as Bluetooth, WiFi Direct, WiFi, RF communication, etc. Although the input device 150 is illustrated as a wireless keyboard, the input device 150 may be any suitable device equipped with data inputting and wireless communication capabilities including, but not limited to, a wireless mouse, a wireless graphics tablet or digitizer with a stylus, etc.

Initially, when the short range wireless communication feature of the input device 150 is turned on, the electronic devices 110, 120, 130, and 140 may discover the input device 150 and identify the input device 150 as a device that can be coupled to the devices 110 to 140. The electronic devices 110 to 140 may then track gaze directions of the user 160 for connecting to the input device 150. For example, if the electronic device 110 determines that the gaze direction of the user 160 is targeted to the electronic device 110 as a target device, it establishes a connection to the input device 150 so that the user 160 may use the input device 150 to operate the target device by inputting data or commands. Subsequently, if electronic device 120 determines that the gaze direction of the user 160 is targeted to the electronic device 120, it establishes a connection with the input device 150. In this manner, the connection of the input device 150 may be switched from one electronic device to another electronic device according to a gaze direction of the user 160.

The electronic devices 110, 120, 130, and 140 include image sensing units 112, 122, 132, and 142, respectively, each of which may be configured to capture images in its field of view. The image sensing units 112, 122, 132, and 142 may be further configured to continuously or periodically capture one or more images that may be used to determine gaze directions of the user 160 for connecting the input device 150 with the electronic devices 110, 120, 130, and 140. As used herein, the term “to periodically capture” refers to repeatedly capturing images, e.g., by the image sensing units, at a predetermined time interval after the first captured image.

In the illustrated embodiment, the images captured by the image sensing units 112, 122, 132, and 142 may include a face of the user 160. The images captured by the image sensing units 112, 122, 132, and 142 may be permanently or temporarily stored in storage units of the respective electronic devices. The image sensing units 112, 122, 132, and 142 may include any suitable number of cameras, image sensors, or video cameras for capturing one or more images. In one embodiment, an image sensing unit may be provided in one of the electronic devices. In this arrangement, the electronic device with the image sensing unit may function as a connection manager for connecting the input device 150 to one of the electronic devices by determining a gaze direction of a user from a captured image and determining a target device among the electronic devices based on the gaze direction.

Each of the electronic devices 110, 120, 130, and 140 may perform a face detection analysis on at least one image captured by the image sensing units 112, 122, 132, and 142, respectively, to determine whether the image includes a face of a person. The face detection analysis may detect a face of a person from a captured image by using any suitable schemes for detecting faces. In one embodiment, a face in an image may be detected by detecting one or more features indicative of a person's face such as eyes, eyebrows, nose, lips, etc. and/or a shape of a candidate region that is indicative of a face of a person. The features and/or the shape of the candidate facial region may then be compared with one or more reference facial features and/or shapes of reference faces to detect the face.

When each of the electronic devices 110, 120, 130, and 140 detects a face of the user 160 in a captured image, a gaze direction of the user 160 in the image may be determined based on at least one eye of the user 160 in the image. In the illustrated embodiment, the user may be looking at a display device 114 of the electronic device 110 along a gaze direction 172 in order to use the electronic device 110. In this case, the image captured by the image sensing unit 112 may include a face of the user 160 who is looking at the display device 114 of the electronic device 110. Since the user 160 is looking at the display device 114, which is a component of the electronic device 110, the electronic device 110 may determine that the gaze direction 172 of the user 160 is targeted to the electronic device 110 as a target device.

On the other hand, the electronic devices 120, 130, and 140 may determine that the respective captured images of the user 160 indicate that the user 160 is not looking at the respective devices. Subsequently, the user 160 may look at the electronic device 120, 130, and 140, along gaze directions 174, 176, and 178, respectively, at different times. In such cases, each of the electronic devices 120, 130, and 140 may determine whether the user 160 is looking at the electronic devices 120, 130, and 140 by determining the gaze directions of the user 160 in captured images of the user 160 at such times.

In the illustrated embodiment, the electronic device 110 may determine the gaze direction 172 from the captured image of the user 160 by detecting at least one eye of the user 160. For determining the gaze direction 172, the electronic device 110 may employ any suitable eye and gaze detection schemes such as a skin-color model, Lucas-Kanade's algorithm, standard eigen analyses (e.g., eigeneye, eigennose, and eigenmouth methods), a Viola and Jones-like eye detector, an active appearance model, a deformable template-based correlation method, an edge detection using an ellipse model for eyes, a parabola model for eyelid, and a circle model for iris. For example, in the case of the circle model for iris, the electronic device 110 may extract an image of at least one eye of the user 160 from the captured image of the user 160 and analyze a position of the iris or pupil of the extracted eyes to determine the gaze direction 172. Similarly, each of the electronic devices 120, 130, and 140 may also determine a gaze direction of the user 160 in a captured image using such eye and gaze detection schemes.

Based on the gaze direction 172 of the user 160, the electronic device 110 may identify itself as a target device to be connected to the input device 150. In this case, the electronic device 110 may communicate with the input device 150 to establish a connection between the electronic device 110 and the input device 150. The user may then operate the electronic device 110 using the input device 150.

Additionally, the electronic devices 110, 120, 130, and 140 may be configured to recognize a face of the user 160 as an authorized user of the input device 150. In this case, the electronic devices 110, 120, 130, and 140 may store a plurality of reference facial features for a face of the authorized user of the input device 150. The electronic devices 110, 120, 130, and 140 may then extract facial features of a face from the captured image and compare the extracted facial features and the reference facial features to identify that the face in the captured image is that of the authorized user. The electronic devices 110, 120, 130, and 140 may also employ any other suitable image processing schemes for recognizing a face of the user 160.

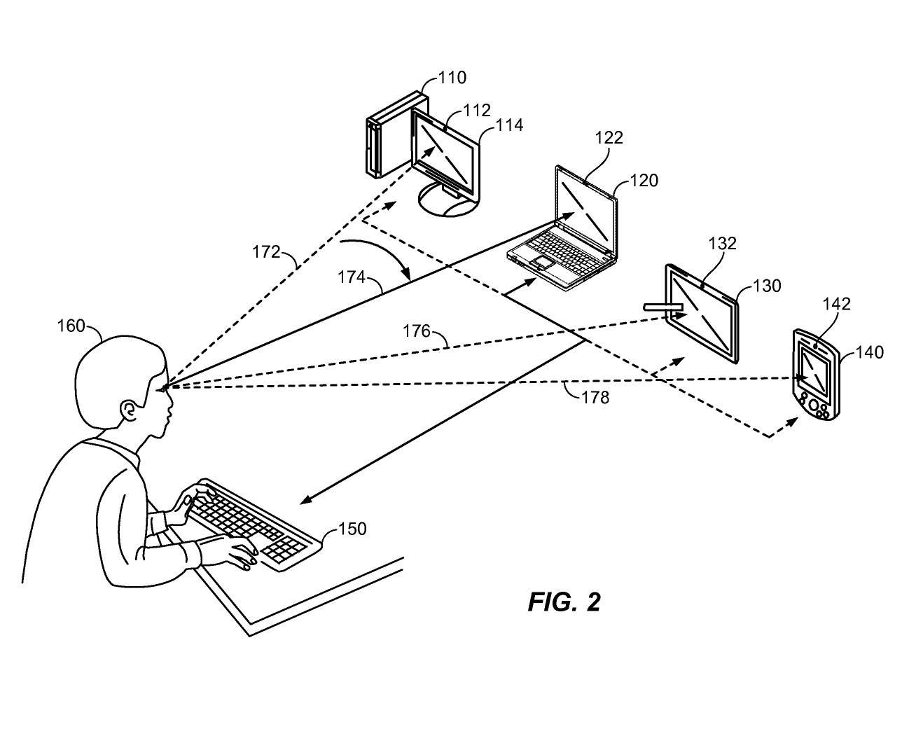

FIG. 2 illustrates the input device 150 configured to switch its connection from the electronic device 110 to the electronic device 120 in response to a change in a gaze direction of the user 160 according to one embodiment of the present disclosure. In this embodiment, while the user 160 operates the electronic device 110 using the input device 150, each of the electronic devices 110, 120, 130, and 140 may be configured to determine a gaze direction of the user 160 by continuously or periodically capturing an image of the user 160. For determining the gaze direction of the user 160, each of the electronic devices 110, 120, 130, and 140 may extract one or more features associated with at least one eye from the captured image and determine the gaze direction of the user 160. Based on the gaze direction of the user 160, the electronic devices 110, 120, 130, and 140 may determine that the gaze direction has changed from one electronic device to another, and a connection to the input device 150 may be switched from one electronic device to another electronic device associated with the gaze direction of the user 160.

In the illustrated embodiment, the user 160 changes his or her gaze from the gaze direction 172 for the electronic device 110 to the gaze direction 174 for the electronic device 120. In this case, the electronic devices 110, 120, 130, and 140 may continuously or periodically capture images of the user 160 and extract one or more features associated with at least one eye of the user 160 in each image. Based on the extracted features, each of the electronic devices 110, 120, 130, and 140 may determine a gaze direction of the user 160. For example, the electronic device 110 may determine that the user 160 is no longer looking in the gaze direction 172 for the electronic device 110 while the electronic device 120 may determine that the user is looking in the gaze direction 174 for the electronic device 120. The electronic device 120 may then identify itself to be a target device to be connected to the input device 150. In this case, a connection of the input device 150 is switched from the electronic device 110 to the electronic device 120, such that the user 160 may operate the electronic device 120 using the input device 150.

In some embodiments, the electronic device 110 that has been determined as a target device may determine another electronic device to be a new target device based on a change in the gaze of the user 160 and the locations of the electronic devices 110, 120, 130, and 140. For example, the image sensing unit 112 of the electronic device 110 may be configured to capture an image within its field of view including the other electronic devices 120, 130, and 140, and the user 160. While being connected to the input device 150, when a face is detected from the captured image, the electronic device 110 may extract one or more features associated with at least one eye from the captured image and determine a gaze direction of the user 160 based on the extracted features. The electronic device 110 may also be configured to identify the electronic devices 120, 130, and 140 from the captured image and determine locations of the electronic devices 120, 130, and 140 with respect to the electronic device 110 in the image.

In this case, the electronic device 110 may determine a change of the target electronic device by associating the gaze direction with one of the other electronic devices 120, 130, and 140 based on the locations of the electronic devices. For example, the electronic device 110 captures an image in which a gaze direction 174 of the user 160 is to the electronic device 120. Accordingly, the electronic device 110 may determine that the electronic device 120 is a new target device by associating the gaze direction 174 with the location of the electronic device 120. In this case, a connection of the input device 150 is switched from the electronic device 110 to the electronic device 120, such that the user 160 may operate the electronic device 120 using the input device 150.

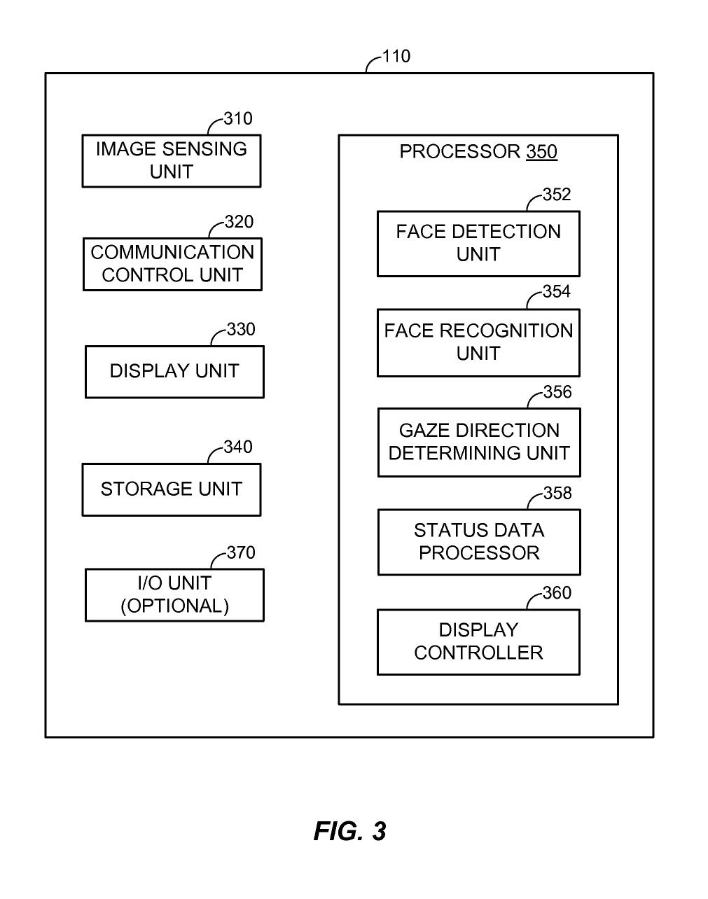

FIG. 3 illustrates a block diagram of the electronic device 110 configured to make a connection with an input device based on a gaze direction of a user, according one embodiment of the present disclosure. The electronic device 110 includes an image sensing unit 310, a communication control unit 320, a display unit 330, a storage unit 340, a processor 350, and an I/O unit 370. In the illustrated embodiment, the processor 350 may include a face detection unit 352, a face recognition unit 354, a gaze direction determining unit 356, a status data processor 358, and a display controller 360. The processor 350 may be implemented using any suitable processing unit such as a central processing unit (CPU), an application processor, a microprocessor, or the like that can execute instructions or perform operations for the electronic device 110. It should be understood that these components may be combined with any electronic devices 110, 120, 130, and 140, or the input device 150 described in this disclosure.

The image sensing unit 310 may be configured to continuously or periodically capture an image in the field of view of the electronic device 110. The image sensing unit 310 may include any suitable number of cameras, image sensors, or video cameras for sensing one or more images. The image captured by the image sensing unit 310 may be provided to the processor 350, which may be configured to determine whether the image includes a face. The processor 350 may be further configured to identify the user 160, and determine a gaze direction of the user 160.

The face detection unit 352 of the processor 350 may be configured to determine whether the image includes a face of a person. The face detection unit 352 may detect one or more features indicative of a person's face such as eyes, eyebrows, nose and lips, etc., and/or a shape of a candidate region that is indicative of a face of a person. The face detection unit 352 may access a face detection database in the storage unit 340 to compare the detected features with reference facial features and/or shapes of reference faces stored in the face detection database to detect the face. The face detection unit 352 may detect a face of a person from a captured image by using any suitable schemes for detecting a face.

In some embodiments, if the face detection unit 352 determines that the captured image does not include a face, the image sensing unit 310 may continue to capture one or more images in its field of view. On the other hand, if the face detection unit 352 determines that the captured image includes a face, the image may then be transmitted to the gaze direction determining unit 356 for determining a gaze direction of the user 160 in the image or to the face recognition unit 354 for determining whether the user 160 is authorized to use the electronic device 110. Alternatively, if more than one face is detected in the captured image, the image may be transmitted to the face recognition unit 354 for verifying the user of the device 110.

The face recognition unit 354 may be configured to receive the images with at least one face, and perform a user identification analysis and/or a user verification analysis by accessing a reference facial feature database in the storage unit 340. The face recognition unit 354 may perform the user identification analysis on a face that has been detected in a received image to determine the identity of the user (e.g., to determine whether the user is an authorized user). On the other hand, the user verification analysis may be performed to verify whether a face detected in a received image is the same as the face of the user of the input device that was detected in previously captured images.

In some embodiments, the face recognition unit 354 may perform the user identification analysis or the user verification analysis by extracting facial features of a face detected in a received image. In the case of the user identification analysis, the reference facial feature database may include reference facial features of the authorized user for use in identifying a face detected in an image as that of the authorized user. For each image received from the image sensing unit 310, the face recognition unit 354 may extract facial features of a face detected in the received image. The face recognition unit 354 may then access the reference facial feature database in the storage unit 340 and identify the user 160 as the authorized user based on the extracted facial features of the user 160. For example, the extracted facial features may be determined to be associated with the authorized user when the extracted facial features and the reference facial features of the authorized user are similar within a threshold value.

The face recognition unit 354 may perform the user verification analysis to verify whether a face detected in a received image is the same as the face of the user of the input device that was detected in previously captured images. In one embodiment, when a face of the user 160 is first detected in an image captured by the image sensing unit 310, the face recognition unit 354 may extract facial features of the user 160 from the image and store the extracted features as reference facial features of the user 160 in the reference facial feature database. When a new image including a face is subsequently received from the image sensing unit 310, the face recognition unit 354 may extract facial features from the new image and compare the extracted facial features to the reference facial features in the reference facial feature database. Based on this comparison, the face recognition unit 354 may determine whether the face in the subsequent image is changed from the face of the user 160 in the previous image. For example, if the extracted facial features and the reference facial features are determined to be dissimilar (using a threshold value), the face in the subsequent image may be determined to have changed from the face of the user 160 in a previous image.

The gaze direction determining unit 356 may be configured to determine a gaze direction of the user 160 when the face detection unit 352 detects a face in the captured image or the face recognition unit 354 recognizes a face of the user 160. The gaze direction of the user 160 is determined by extracting one or more features associated with at least one eye of the user 160 in the captured image. For example, the gaze direction determining unit 356 may analyze the extracted features to determine a position of the iris or pupil of the eye which indicates the gaze direction of the user. Based on the determined gaze direction of the user 160, the gaze direction determining unit 356 may determine itself as a target device to be connected with the input device 150. In this case, the gaze direction determining unit 356 transmits a signal indicating that the electronic device 110 is the target device to the communication control unit 320. The communication control unit 320 may then connect to the input device 150 and/or notify the other electronic devices 120, 130, and 140 that the electronic device 110 is connected to the input device 150.

In another embodiment, the gaze direction determining unit 356 may determine that another device in the field of view of the electronic device 110 is the target device for the input device 150 based on the gaze direction of the user 160. In this case, the gaze direction determining unit 356 may also determine locations of other electronic devices and the user 160 included in the captured image. For example, the gaze direction determining unit 356 may be further configured to identify the other electronic devices and the user 160 from the captured image, and determine locations of the other electronic devices and the user 160 with respect to the electronic device 110. As such, the gaze direction determining unit 356 may identify the target electronic device by associating the location of one of the electronic devices with the gaze direction. The gaze direction determining unit 356 may then transmit a signal indicating the target device to the communication control unit 320. The communication control unit 320 may then notify the target device to establish a connection with the input device 150, and broadcast or transmit a signal indicating that the target device is connected to the input device 150.

The status data processor 358 may be configured to process status data that may be received from the other electronic devices. The processed status data may be displayed on the display unit 330 of the electronic device 110 when the electronic device 110 is determined to be the target device. The status data may include at least one of an event notification, a still image of the current display, or a streamed video image of the display of the electronic devices 120, 130, and 140. Additionally, the status data processor 358 may be configured to prepare and output status data of the electronic device 110 to the target device for display, when one of the other electronic devices 120 to 140 is determined as the target device. For example, if the electronic device 110 is not the target device and a music download is completed via the Internet in the electronic device 110, the status data processor 358 prepares an event notification that the music download is complete and outputs the event notification to the target device. The wired or wireless connection with the other electronic devices may be established by the communication control unit 320.

The display controller 360 may be configured to control the display unit 330. When the status data is received from the electronic devices 120, 130, and 140, the status data processor 358 may process the status data and forward the processed status data to the display controller 360, such that the display controller 360 controls the display unit 330 to display the status data. In this case, the status data processor 358 processes the status data, such as an event notification, an image, etc., so that it is readily recognizable by the user 160. The event notification may be processed to be in a text format, and the image may be processed to be resized to fit within a predetermined size and to add text descriptions for the image. For example, if the status data is a still image of the current display of another electronic device, the status data processor 358 may resize the image such that the resized image is output to the display unit 330 for display.

The communication control unit 320 may be configured to connect the electronic device 110 to the input device 150 or at least one of the other electronic devices 120 to 140. For example, if the electronic device 110 is determined to be the target device, the communication control unit 320 establishes a connection with the input device 150. Once a connection between the electronic device 110 and the input device 150 is established, the communication control unit 320 may be further configured to output (e.g., broadcast or transmit) a signal indicating that the electronic device 110 is connected to the input device 150 to other electronic devices in order to receive their status data.

The communication control unit 320 may also be configured to connect the electronic device 120, 130, or 140 to the input device 150. For example, the electronic device 110 may determine that one of the electronic devices 120 to 140 is the target device based on a gaze direction of the user 160. In this case, the electronic device 110 may act as a connection manager which is configured to establish a connection between a target device and the input device 150. When the target device is determined, the communication control unit 320 may directly establish a connection between the target device and the input device 150.

The display unit 330 may be configured to display the status data received from the display controller 360. The display unit 330 may be any suitable type of display device including, but not limited to, a LCD (liquid crystal display), a OLED (organic light-emitting device), etc., which may be configured to display information and images for user's view.

The storage unit 340 may be configured to include a face detection database for detecting a face, and a reference facial feature database for recognizing the user 160. The face detection database may include reference facial features and/or shapes of reference faces for detecting a face. The reference facial features may be one or more features indicative of a person's face such as eyes, eyebrows, nose and lips, etc. Further, the reference facial feature database may include reference facial features for identifying an authorized user and for verifying that the facial features extracted by the face recognition unit 354 have not changed from the previously extracted facial features. The storage unit 340 may also store reference features indicative of the iris or pupil of eyes of the user 160 to determine a gaze direction of the user 160. The storage unit 340 may be implemented using any suitable type of a memory device including, but not limited to, a RAM (Random Access Memory), a ROM (Read Only Memory), an EEPROM (Electrically Erasable Programmable Read Only Memory), or a flash memory to store various types of information and data.

The I/O unit 370 may be configured to optionally receive input from the user 160 when the input device 150 is connected to the electronic device 110. In one embodiment, based on the user's preference, the user 160 may operate the electronic device 110 by using the I/O unit 370 and/or the input device 150. The I/O unit 370 may be a keyboard, a mouse, or the like which may be dedicated for inputting a user's request in the electronic device 110. For example, when the connection is established between the input device 150 and the electronic device 110 as described above, the I/O unit 370 may be disabled. It is appreciated that the electronic device 110 can be operated independent from the other electronic devices 120 to 140 or the electronic device 110 can be a hardware or software subsystem implemented in any one of the electronic devices 120 to 140.

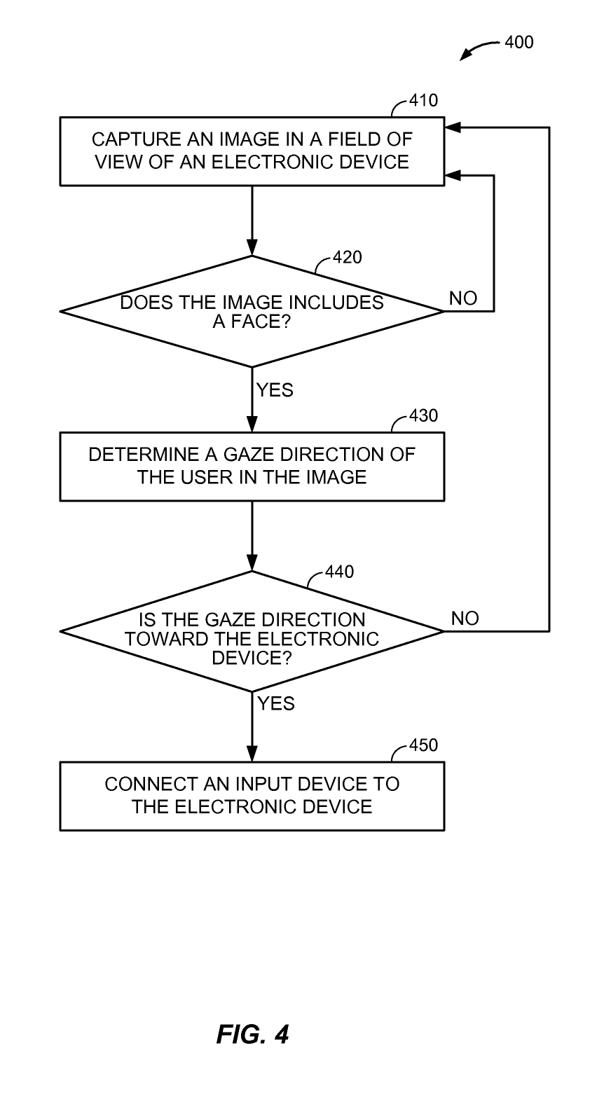

FIG. 4 illustrates a flow chart 400 of a method for determining an electronic device as a target device for connecting to an input device, according to one embodiment of the present disclosure. Initially, an image sensing unit of the electronic device may capture an image in the field of view of the electronic device, at 410. One or more images may be periodically or continuously captured by the electronic device and analyzed for determining a gaze direction of a user of the input device.

Based on the received image, the electronic device may determine whether the image includes a face by using a face detection analysis, at 420. If no face is detected (NO at 420), the electronic device may continue to capture one or more images in a field of view of the electronic device. On the other hand, if a face is detected (YES at 420), a gaze direction of the face of the user in the image may be determined, at 430. The gaze direction may be determined by extracting one or more features associated with at least one eye of the face in the image. Additionally, when a face is detected (YES at 420), the detected face may also be analyzed to determine whether the face is indicative of the authorized user of the electronic device. The facial recognition analysis may be used to identify the authorized user by comparing facial features of the face in the image with reference facial features of the authorized user. If the detected face in the image is not indicative of the authorized user, a subsequent image may be captured.

Based on the gaze direction determined at 430, it is determined whether the gaze direction is toward the electronic device, at 440. If the gaze direction is determined to be toward the electronic device (YES at 440), the electronic device connects to the input device, at 450. On other hand, if the gaze direction is not toward the electronic device (NO at 440), the electronic device may continue to capture one or more images in a field of view of the electronic device, at 410. In some embodiments, if the electronic device determines that another electronic device is the target device based on the gaze direction and the locations of other electronic devices in the captured image, the electronic device may broadcast or transmit a signal to the target device indicating that the target device should establish a connection with the input device.

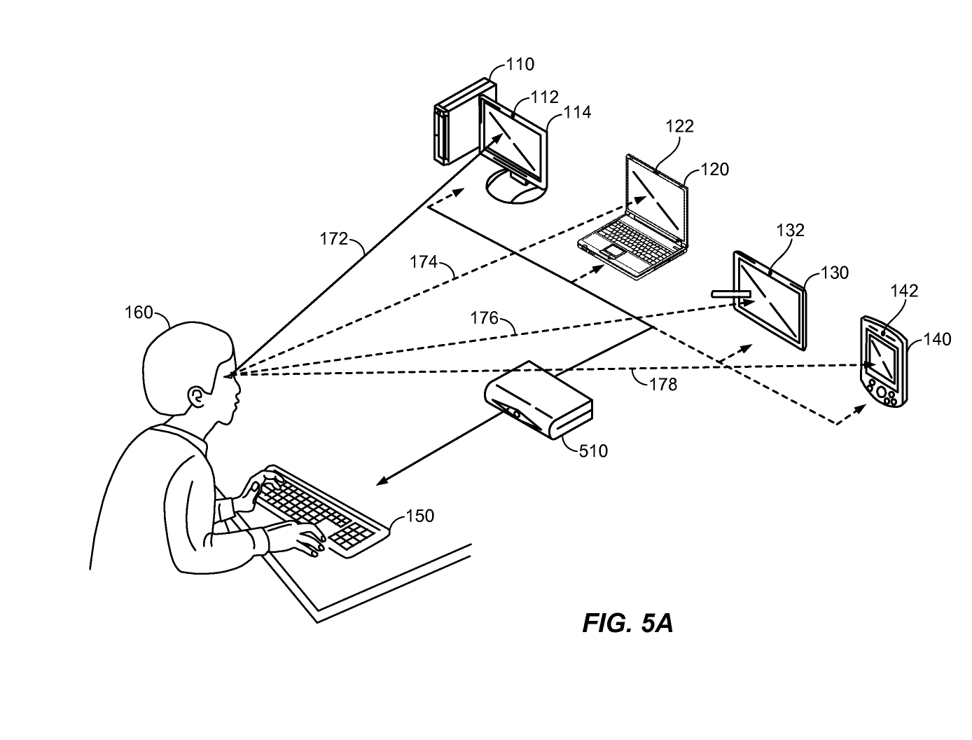

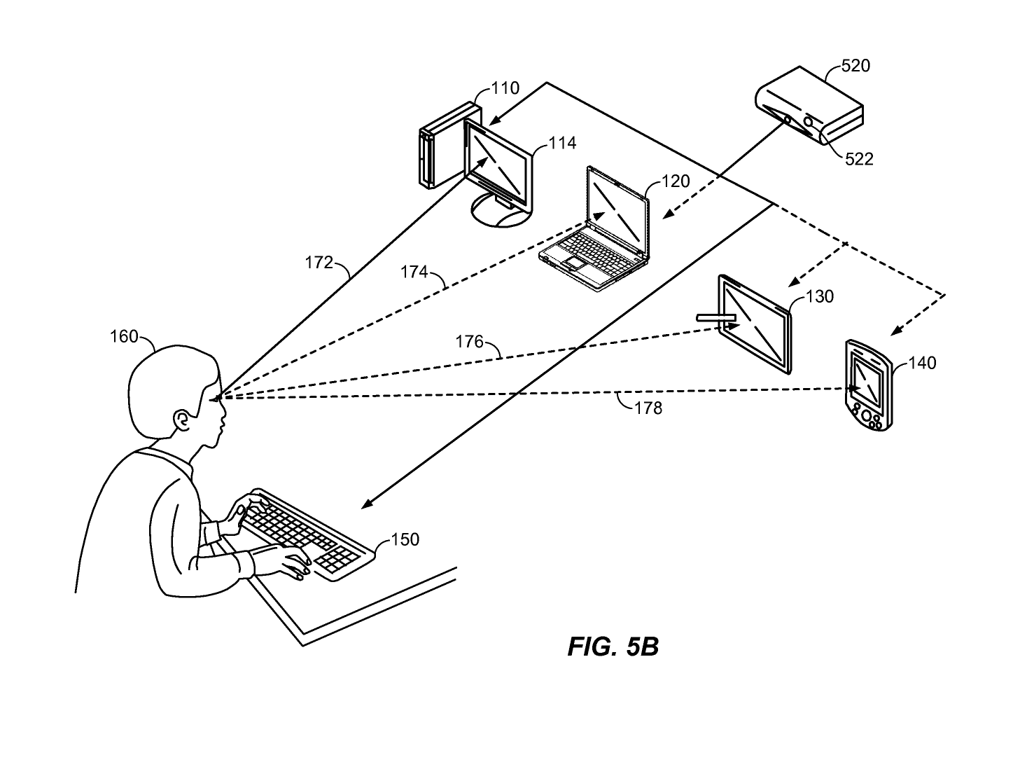

FIG. 5A illustrates the electronic devices 110, 120, 130, and 140 that may be connected to an input device 150 via a connection manager 510 based on a gaze direction of a user 160, according to one embodiment of the present disclosure. The connection manager 510 and the electronic devices 110, 120, 130, and 140 may be configured to communicate wirelessly or via a wired connection. The connection manager 510 may also be configured to connect with the input device 150 wirelessly or via a wired connection.

In the illustrated embodiment, the electronic devices 110, 120, 130, and 140 are configured to capture images of the user 160 and transmit the images to the connection manager 510. The connection manager 510 may receive the images from the electronic devices 110, 120, 130, and 140, and determine whether the images include a face. When the face is detected in a received image, the connection manager 510 may extract one or more features associated with at least one eye from the image and determine a gaze direction of the user 160 based on the extracted features.

As illustrated, the user 160 is gazing at the electronic device 110 as a target device. Thus, the connection manager 510 may determine that the user 160 is looking at the electronic device 110 as a target device based on the image received from the electronic device 110 that captures an image of the user 160 looking in a gaze direction 172. Once the target device is identified, the connection manager 510 connects the electronic device 110 as the target device to the input device 150. The user 160 may then operate the electronic device 110 using the input device 150.

In one embodiment, for security, the connection manager 510 may be further configured to identify the face included in the images as that of an authorized user in addition to detecting the face. In this case, the connection manager 510 may extract facial features of the user 160 from the captured images, and perform a face recognition analysis. The facial features of the user 160 may be stored in a storage unit of the connection manager 510 and generated during the initial set up process to identify the authorized user. Alternatively, the facial features may be generated from the initially received image captured by at least one of the image sensing units 112, 122, 132, and 142 of the electronic device 110, 120, 130, and 140. A gaze direction of the user 160 may be determined once the face is identified to be that of the authorized user.

FIG. 5B illustrates the electronic devices 110, 120, 130, and 140 that may be connected to the input device 150 via a connection manager 520 equipped with an image sensing unit 522, according to one embodiment of the present disclosure. The electronic devices 110, 120, 130, and 140 may be located within a field of view of the image sensing unit 522 in the illustrated embodiment. The connection manager 520 may be configured to capture an image of the user 160 and determine a gaze direction of the user 160 from the captured image. In one embodiment, the electronic device 110, 120, 130, and 140 may not be equipped with an image sensing unit and image processing abilities to detect a face, determine an identity of the face, or determine a gaze direction of the user. The connection manager 520 and the electronic devices 110, 120, 130, and 140 may be configured to communicate wirelessly or via a wired connection. The connection manager 520 may also be configured to connect with the input device 150 wirelessly or via a wired connection.

The image sensing unit 522 in the connection manager 520 may be configured to capture an image within its field of view including the electronic devices 110, 120, 130, and 140, and the user 160. When a face is detected from the captured image, the connection manager 520 may extract one or more features associated with at least one eye from the captured images and determine a gaze direction of the user 160 based on the extracted features. The connection manager 520 may also be configured to identify the electronic devices 110, 120, 130, and 140 from the image and determine locations of the electronic devices 110, 120, 130, and 140 with respect to the connection manager 520 in the image.

In one embodiment, the connection manager 520 may determine a target electronic device based on the gaze direction and the locations of the electronic devices 110, 120, 130, and 140. For example, the connection manager 520 may associate a gaze direction to an electronic device based on the location of the electronic device. In the illustrated embodiment, the image sensing unit 522 captures an image in which a gaze direction 172 of the user 160 is to the electronic device 110. Accordingly, the connection manager 520 may determine that the electronic device 110 is the target device based on the gaze direction 172. The connection manager 520 may then connect the electronic device 110 to the input device 150.

In some embodiments, the user 160 may subsequently change his or her gaze from the gaze direction 172 for the electronic device 110 to a gaze direction 178 for the electronic device 140. In this case, the connection manager 520 may continuously or periodically capture images of the user 160 and extract one or more features associated with at least one eye of the user 160 in each image. Based on the extracted features, the connection manager 520 may determine a gaze direction of the user 160. If the connection manager 520 determines that the gaze direction has changed from the electronic device 110 to, for example, the electronic device 140 based on the extracted features, the connection manager 520 may switch the connection of the input device 150 from the electronic device 110 to the electronic device 140.

It is appreciated that the connection manager 510 or 520 can be a separate device or the connection manager 510 or 520 can be hardware or software included in one of the electronic devices 110, 120, 130, and 140. Further, the electronic devices 110, 120, 130, and 140 and the connection manager 510 or 520 can be connected by a wire or wirelessly. Additionally, it should be understood that the components of FIG. 3 may be combined with the connection manager 510 or 520 described in this disclosure.

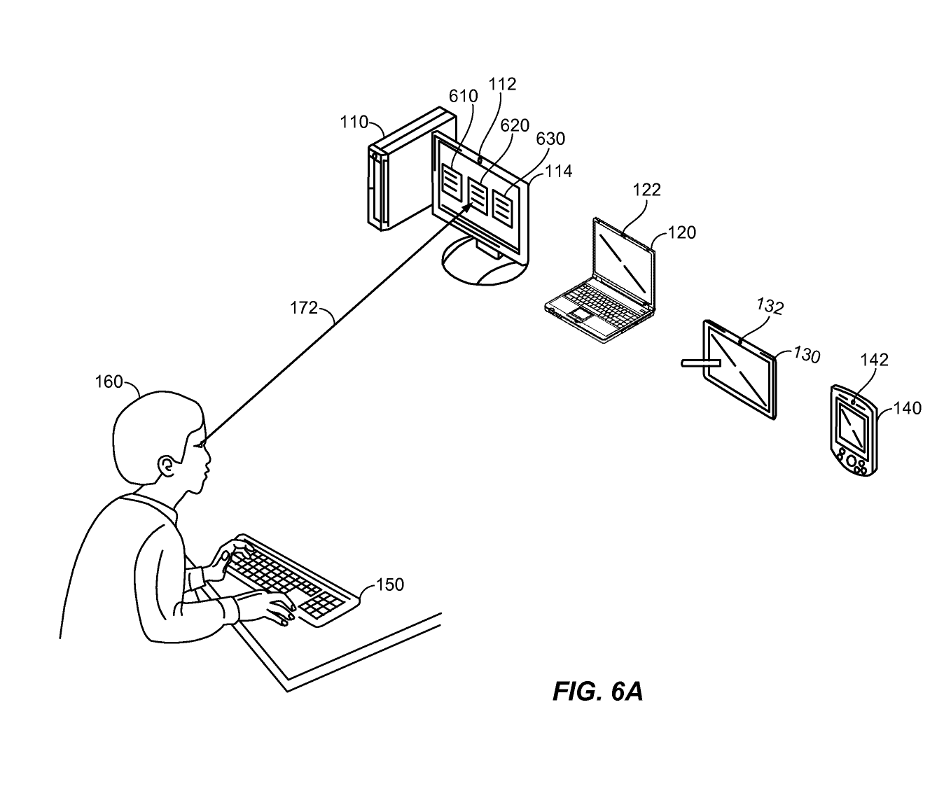

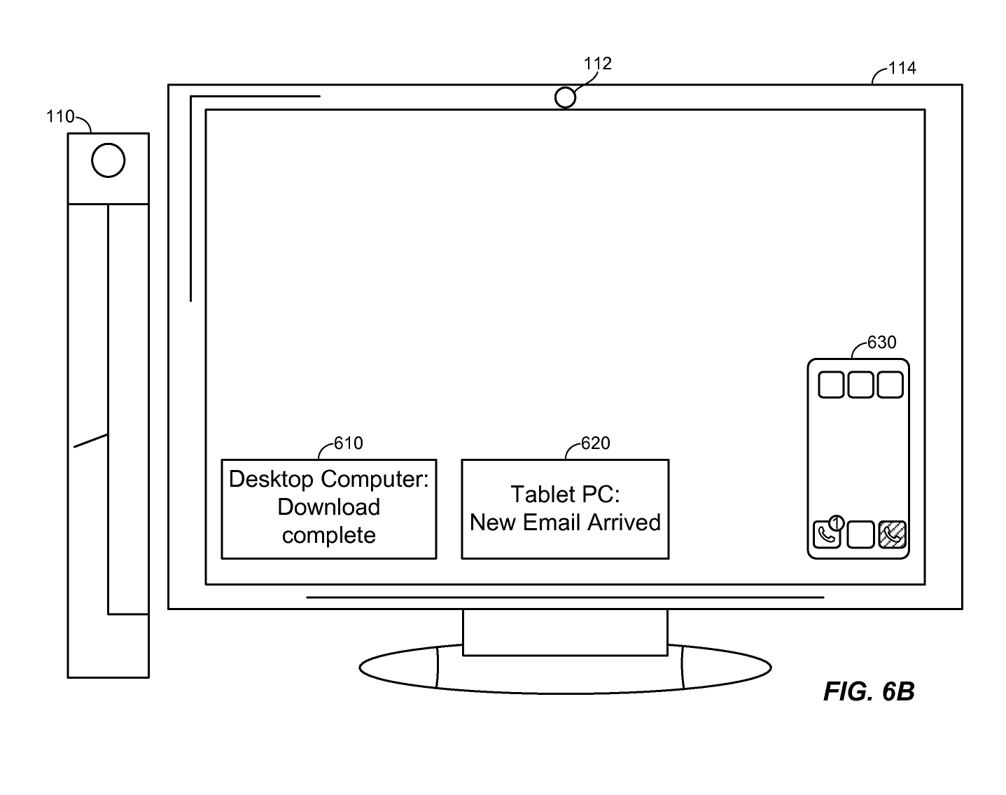

FIGS. 6A and 6B illustrate the electronic device 110 connected with the input device 150 and configured to display pop-up windows 610, 620, and 630 indicating status data received from the electronic devices 120, 130, and 140, respectively, according to one embodiment of the present disclosure. In FIG. 6A, the electronic device 110 is connected to the input device 150 after the gaze direction 172 of the user 160 is determined based on a capture image of the user 160. In the illustrated embodiment, the electronic devices 110, 120, 130, and 140 may be connected to each other by wired or wireless communication method such as a peer-to-peer communication method. The input device 150 may switch its connection to any other electronic devices 120, 130, and 140 from the electronic device 110 in response to a change in a gaze direction of the user 160.

In this embodiment, once the electronic device 110 is connected to the input device 150, the electronic device 110 may broadcast or transmit a signal indicating that the input device 150 is connected to the electronic device 110 to the electronic devices 120, 130, and 140. In response to the signal from the electronic device 110, the electronic devices 120, 130, and 140 may transmit their status data to the electronic device 110 for display. The status data may include at least one of an event notification, a still image of the current display, or a streamed video image of the electronic devices 120, 130, or 140. The received status data of the electronic devices 120, 130, and 140 may be displayed on the display device 114 of the electronic device 110 as notifications or images 610, 620, and 630.

For example, as shown in FIG. 6B, the status data from the electronic devices 120, 130, and 140 may be displayed on the display device 114 of the electronic device 110 as three notifications 610, 620, and 630 represented in respective pop-up windows. In this case, while the user 160 operates the electronic device 110 using the input device 150, the user 160 may view status data relating to the electronic devices 120, 130, and 140. The notifications 610, 620, and 630 may be in a text format or an image of the display of the corresponding electronic device.

In the illustrated embodiment, the pop-up window 610 indicates that the electronic device 120 completed a download of a file, and is displayed on the display device 114. Similarly, the electronic device 110 displays the pop-up window 620 indicating that the electronic device 130 received a new email on the display device 114. In addition, an image of the current display of the electronic device 140 may be displayed as the pop-up window 630 on the display device 114. In the illustrated example of the pop-up window 630, the image of the current state of the electronic device 140 indicates a missed call. Although the notifications are illustrated as a pop-up window, the notifications may be text, sound or any other suitable form of notification that may notify the user of the current status of the electronic device 120, 130, and 140.

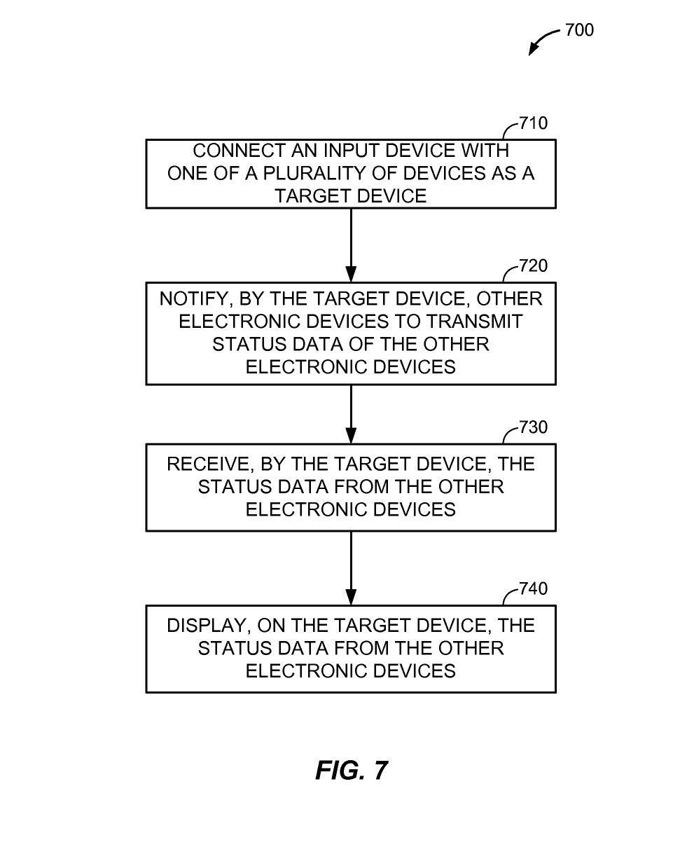

FIG. 7 illustrates a flow chart 700 in which a target device connected to an input device receives status data of other electronic devices which are not connected to the input device, according to one embodiment of the present disclosure. Initially, based on a gaze direction of a user of the input device, a target device may be determined among a plurality of electronic devices and connected to the input device, at 710. Upon connection with the input device, the target device may notify the other electronic devices to transmit status data of the other electronic devices, at 720. For example, the target device may broadcast its connection to the input device by using a short range wireless communication method such as Bluetooth, WiFi, etc.

In response to the notification of the connection between the target device and the input device, the other electronic devices may transmit the status data of the other electronic devices to the target device. The target device may then receive the status data from the other electronic devices, at 730, and display the status data from the other electronic devices on a screen of the target device, at 740. As long as the target device is connected with the input device, the target device may receive status data of the other electronic devices, periodically or continuously.

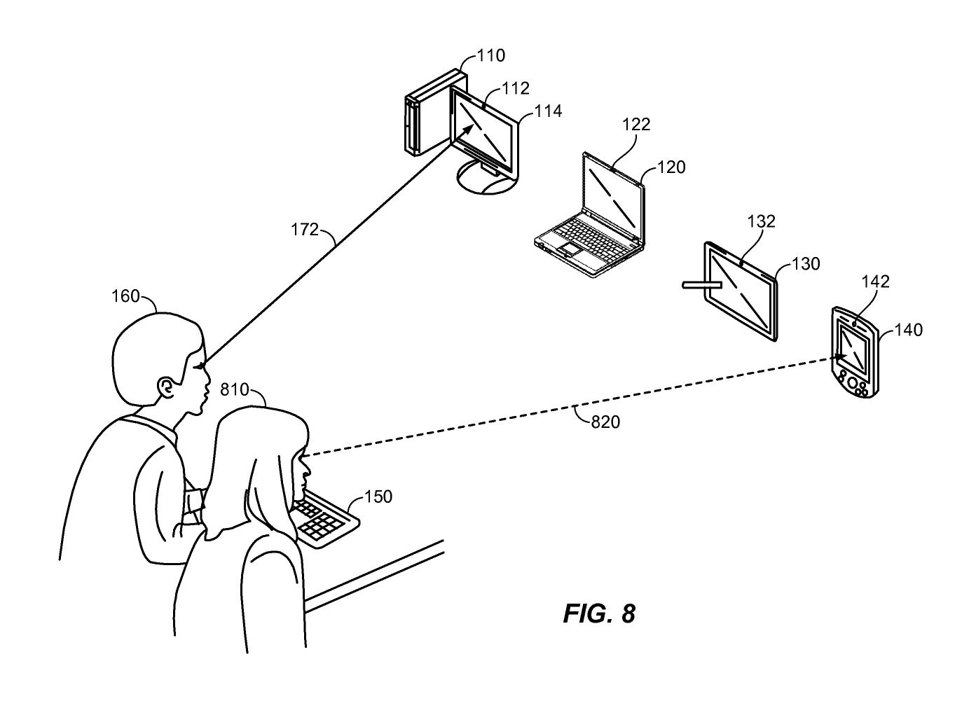

FIG. 8 illustrates the electronic devices 110, 120, 130, and 140 that may verify the user 160 in a received image having the same face that was detected in previously captured images, according to one embodiment of the present disclosure. The electronic devices 110, 120, 130, and 140 may be configured to perform a user verification analysis to verify whether a face detected in a captured image is the same as the face of the user of the input device that was detected in previously captured images. Each of the electronic devices 110, 120, 130, and 140 may extract facial features of the user 160 from previously captured images and store at least part of the extracted facial features as reference facial features in a reference facial feature database of respective storage units. In some embodiments, the electronic devices 110 to 140 may store the most recent extracted facial features of the user 160 and update the facial features in the reference facial feature database when a subsequent image including the face of the user 160 is captured.

In the illustrated embodiment, the user 160 is looking in the gaze direction 172 for the electronic device 110, and the input device 150 is connected to the electronic device 110. Each of the electronic devices 110, 120, 130, and 140 may be configured to continuously and periodically capture an image of the user 160 for determining a change in the user's gaze direction. For example, the electronic device 110 may detect the face of the user 160 as well as a face of a new user 810 from the captured image.

To verify the user 160, the electronic device 110 may extract the facial features of the user 160 and the new user 810 from the captured image and perform a user verification analysis on the extracted facial features. The user verification analysis may be performed using any suitable face verification algorithms, such as Principal Component Analysis, Linear Discriminate Analysis, Elastic Bunch Graph Matching using the Fisherface algorithm, the Hidden Markov model, the Multilinear Subspace Learning using tensor representation, the neuronal motivated dynamic link matching, and etc. For example, the device 110 may access the reference facial feature database and compare the extracted facial features of the user 160 and the new user 810 with the reference facial features of the user 160. Based on this comparison, the electronic device 110 may determine whether the face of the new user 810 in the subsequent image is different from the face of the user 160 in the previous image. For example, if the extracted facial features of the new user 810 and the reference facial features are determined to be dissimilar (based on a threshold value), the face of the new user 810 in the subsequent image may be determined to be different from the face of the user 160 in a previous image. As such, the electronic device 110 may determine that the user 160 among the detected faces in the image is the previous user of the input device 150. In this case, a gaze direction 820 of the new user 810 may be ignored and the electronic devices 110, 120, 130, and 140 may continue to determine the gaze direction of the user 160.

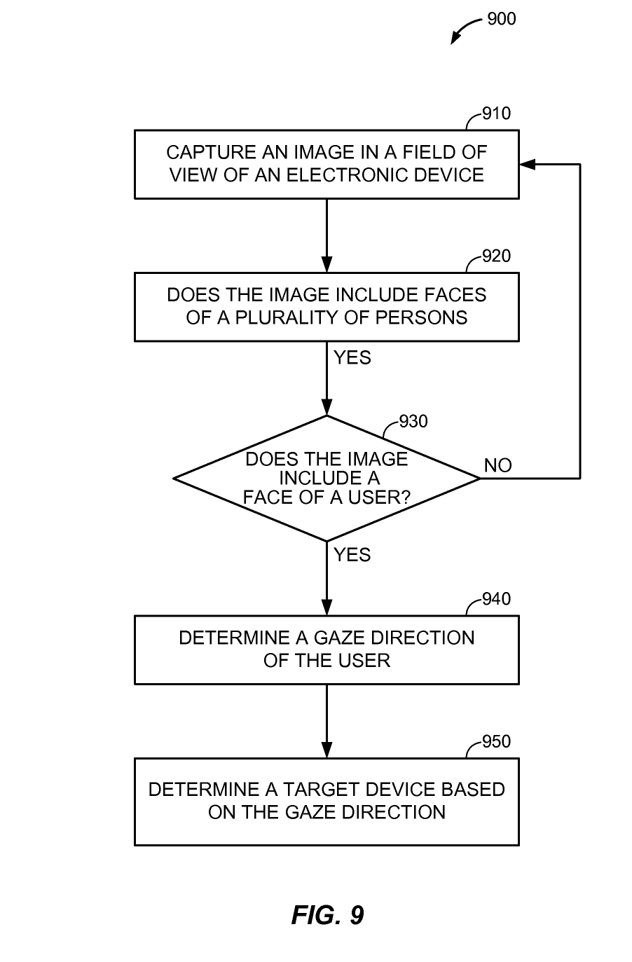

FIG. 9 illustrates a flow chart 900 of a method for verifying the user 160 for the input device when two users are detected, according to one embodiment of the present disclosure. Initially, an image sensing unit of an electronic device captures an image in the field of view of the electronic device, at 910. Based on the captured image, the electronic device may determine whether the image includes more than one face, at 920. To detect the faces, facial features in the captured image may be extracted and a face detection analysis may be performed on the extracted facial features. If more than one face is detected, the electronic device may determine whether the image includes the face of the user 160 among the detected faces, at 930. Further, a user verification analysis may be performed on the image to verify the user 160. For the user verification analysis, facial features of the two users may be extracted from the image. The electronic device may then access a reference facial feature database, which stores facial features extracted from previously captured images of the user 160 as reference facial features of the user 160. The reference facial features may be compared with the extracted facial features of the two users. Based on the comparison, the user 160 among the two users may be verified as the previous user of the input device. If it is verified that both of the two users are not the user 160, a subsequent image may be captured, at 910.

On the other hand, if it is verified that the image includes the face of the user 160 (YES at 930), a gaze direction of the user may be determined, at 940. The gaze direction may be determined by determining a position of the iris or pupil of eyes of the face in the image. The electronic device may then determine a target device based on the determined gaze direction, at 950.

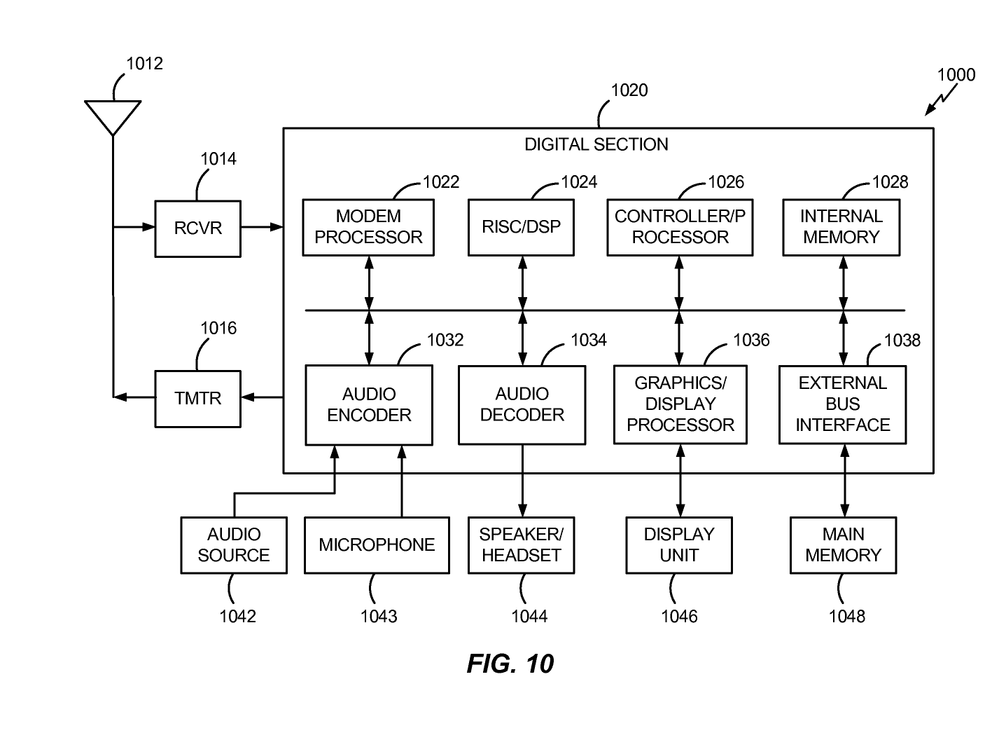

FIG. 10 is a block diagram of an exemplary electronic device 1000 in which the methods and apparatus for connecting an input device and one of a plurality of electronic devices as a target device may be implemented, according to one embodiment of the present disclosure. The configuration of the electronic device 1000 may be implemented in the electronic devices according to the above embodiments described with reference to FIGS. 1 to 9. The electronic device 1000 may be a cellular phone, a smartphone, a tablet computer, a laptop computer, a desktop computer, a terminal, a handset, a personal digital assistant (PDA), a wireless modem, a cordless phone, etc. The wireless communication system may be a Code Division Multiple Access (CDMA) system, a Broadcast System for Mobile Communications (GSM) system, Wideband CDMA (WCDMA) system, Long Term Evolution (LTE) system, LTE Advanced system, etc. Further, the electronic device 1000 may communicate directly with another mobile device, e.g., using Wi-Fi Direct or Bluetooth.

The electronic device 1000 is capable of providing bidirectional communication via a receive path and a transmit path. On the receive path, signals transmitted by base stations are received by an antenna 1012 and are provided to a receiver (RCVR) 1014. The receiver 1014 conditions and digitizes the received signal and provides samples such as the conditioned and digitized digital signal to a digital section for further processing. On the transmit path, a transmitter (TMTR) 1016 receives data to be transmitted from a digital section 1020, processes and conditions the data, and generates a modulated signal, which is transmitted via the antenna 1012 to the base stations. The receiver 1014 and the transmitter 1016 may be part of a transceiver that may support CDMA, GSM, LTE, LTE Advanced, etc.

The digital section 1020 includes various processing, interface, and memory units such as, for example, a modem processor 1022, a reduced instruction set computer/digital signal processor (RISC/DSP) 1024, a controller/processor 1026, an internal memory 1028, a generalized audio encoder 1032, a generalized audio decoder 1034, a graphics/display processor 1036, and an external bus interface (EBI) 1038. The modem processor 1022 may perform processing for data transmission and reception, e.g., encoding, modulation, demodulation, and decoding. The RISC/DSP 1024 may perform general and specialized processing for the electronic device 1000. The controller/processor 1026 may perform the operation of various processing and interface units within the digital section 1020. The internal memory 1028 may store data and/or instructions for various units within the digital section 1020.

The generalized audio encoder 1032 may perform encoding for input signals from an audio source 1042, a microphone 1043, etc. The generalized audio decoder 1034 may perform decoding for coded audio data and may provide output signals to a function determining engine 1044. The graphics/display processor 1036 may perform processing for graphics, videos, images, and texts, which may be presented to a display unit 1046. The EBI 1038 may facilitate transfer of data between the digital section 1020 and a main memory 1048.

The digital section 1020 may be implemented with one or more processors, DSPs, microprocessors, RISCs, etc. The digital section 1020 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein are implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein are applied to other variations without departing from the spirit or scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, performed by a connection manager, for connecting an input device and one of a plurality of electronic devices as a target device, comprising:
detecting a face of a user in a captured image;
determining a first gaze direction of the user from the face of the user in the captured image;
determining the target device in the plurality of electronic devices based on the first gaze direction; and
connecting the input device and the target device.

2. The method of claim 1, wherein at least one of the electronic devices is configured to include the connection manager.

3. The method of claim 1, further comprising receiving, by the target device, status data of at least one of the other electronic devices.

4. The method of claim 3, wherein the status data includes at least one of an image of a display screen and a notification of an event in at least one of the other electronic devices.

5. The method of claim 1, further comprising:
capturing a subsequent image of the user;
detecting the face of the user in the subsequent image;
determining a second gaze direction of the user to one of the plurality of electronic devices in the subsequent image; and
connecting the input device and the one of the plurality of electronic devices based on the second gaze direction.

6. The method of claim 5, wherein the subsequent image includes at least one face.

7. The method of claim 6, wherein detecting the face of the user further comprises verifying that the at least one face in the subsequent image is indicative of the face of the user.

8. The method of claim 1, wherein detecting the face of the user further comprises:
extracting facial features of the user from the captured image; and
identifying the face of the user as a face of an authorized user based on the extracted facial features.

9. The method of claim 1, wherein the input device is at least one of a keyboard, a mouse, and a graphics tablet with a stylus.

10. An electronic device for connecting an input device and one of a plurality of electronic devices as a target device, comprising:
a face detection unit configured to detect a face of a user in a captured image;
a gaze direction determining unit configured to determine a first gaze direction of the user from the face of the user in the captured image, and determine the target device in the plurality of electronic devices based on the first gaze direction; and
a communication control unit configured to connect the input device and the target device.

11. The electronic device of claim 10, wherein the electronic device is the target device.

12. The electronic device of claim 10, wherein the communication control unit is further configured to receive status data of at least one of the other electronic devices.

13. The electronic device of claim 12, wherein the status data includes at least one of an image of a display screen and a notification of an event in at least one of the other electronic devices.

14. The electronic device of claim 10, further comprising an image sensing unit configured to capture a subsequent image of the user,
wherein the face detection unit is further configured to detect the face of the user in the subsequent image,
wherein the gaze direction determining unit is further configured to determine a second gaze direction of the user to one of the plurality of electronic devices in the subsequent image, and
wherein the communication control unit is further configured to connect the input device and the one of the plurality of electronic devices based on the second gaze direction.

15. The electronic device of claim 14, wherein the subsequent image includes at least one face.

16. The electronic device of claim 15, further comprising a face recognition unit configured to verify that the at least one face in the subsequent image is indicative of the face of the user.

17. The electronic device of claim 10, further comprising a face recognition unit configured to extract facial features of the user from the captured image, and identify the face of the user as a face of an authorized user based on the extracted facial features.

18. The electronic device of claim 10, wherein the input device is at least one of a keyboard, a mouse, and a graphics tablet with a stylus.

19. A non-transitory computer-readable storage medium of a connection manager comprising instructions for connecting an input device and one of a plurality of electronic devices as a target device, the instructions causing a processor of the connection manager to perform the operations of:
detecting a face of a user in a captured image;
determining a first gaze direction of the user from the face of the user in the captured image;
determining the target device in the plurality of electronic devices based on the first gaze direction; and
connecting the input device and the target device.

20. The medium of claim 19, wherein at least one of the electronic devices is configured to include the connection manager.

21. The medium of claim 19, wherein the target device is configured to receive status data of at least one of the other electronic devices.

22. The medium of claim 21, wherein the status data includes at least one of an image of a display screen and a notification of an event in at least one of the other electronic devices.

23. The medium of claim 19, wherein the instructions further cause the processor of the connection manager to perform the operations of:
capturing a subsequent image of the user;
detecting the face of the user in the subsequent image;
determining a second gaze direction of the user to one of the plurality of electronic devices in the subsequent image; and
connecting the input device and the one of the plurality of electronic devices based on the second gaze direction.

24. The medium of claim 23, wherein the subsequent image includes at least one face.

25. The medium of claim 24, wherein the instruction of detecting the face of the user further comprises verifying that the at least one face in the subsequent image is indicative of the face of the user.

26. An electronic device for connecting an input device and one of a plurality of electronic devices as a target device, comprising:
means for detecting a face of a user in a captured image;
means for determining a first gaze direction of the user from the face of the user in the captured image, and determining the target device in the plurality of electronic devices based on the first gaze direction; and
means for connecting the input device and the target device.

27. The electronic device of claim 26, further comprising:
means for capturing a subsequent image of the user;
means for detecting the face of the user in the subsequent image;
means for determining a second gaze direction of the user to one of the plurality of electronic devices in the subsequent image; and
means for connecting the input device and the one of the plurality of electronic devices based on the second gaze direction.

28. The electronic device of claim 27, wherein the subsequent image includes at least one face.

29. The electronic device of claim 28, further comprising means for verifying that the at least one face in the subsequent image is indicative of the face of the user.

30. The electronic device of claim 26, wherein the target device is configured to receive status data of at least one of the other electronic devices.
